(19) United States
(12) Patent Application Publication
(10) Pub. No.: US 2008/0185466 A1
(43) Pub. Date: Aug. 7, 2008

(54) SOLIDS REDUCTION PROCESSOR

(75) Inventor: Wendell E. Howard, Austin, TX (US)

Correspondence Address: HUFFMAN LAW GROUP, P.C., 1900 MESA AVE., COLORADO SPRINGS, CO, 80906, US

(73) Assignee: DYNACORP ENGINEERING INC., Austin, TX (US)

(21) Appl. No.: 11/423,522

(22) Filed: Jun. 12, 2006

Related U.S. Application Data
(60) Provisional application No. 60/691,854, filed on Jun. 17, 2005.

(51) Int. Cl. B02C 13/00; B02C 13/28; B02C 13/282

(52) U.S. Cl. 241/187; 241/188.1; 241/194; 241/195; 241/287

(57) ABSTRACT

A solids reduction processor has a pair of opposed parallel rotor assemblies which are rotationally driven in opposite directions to pulverize solids dropped into the processor. Each assembly comprises a shaft, disc sets removably secured to the shafts, and circumferentially spaced sets of outwardly projecting hammer members removably secured to the disc sets for limited pivotal movement relative thereto. Operational abrasion of the shafts and discs is substantially reduced by virtue of the hammer sets on each rotor assembly being axially aligned with the hammer sets on the other rotor assembly. Additionally, since all of the discs from may be removed from their shafts, individual discs may be replaced without the necessity of replacing the whole rotor assembly. Particle reduction efficiency within the processor housing is increased by the use within the processor housing of top and side-mounted breaker bars having particle impact surfaces sloped both horizontally and vertically.

### CROSS-REFERENCE TO RELATED APPLICATION

This application claims the benefit of the filing date of U.S. Provisional Application Ser. No. 60/691,854 filed on Jun. 17, 2005 and entitled “SOLIDS REDUCTION PROCESSOR”, such provisional application being hereby incorporated herein by reference in its entirety.

### BACKGROUND OF THE INVENTION

The present invention generally relates to solids reduction and, in a representatively illustrated embodiment thereof, more particularly relates to a commercial machine for reducing solid materials.

Solids reduction is the process by which certain materials are ground, crushed or pulverized from a certain input size to a prescribed, smaller output size. Solids reduction technology is utilized in a wide array of commercial applications such as, for example, cement production, mining, utility and chemical processes, oil and gas processing, paper production and various agricultural applications.

Various devices have been developed and utilized to reduce the size of solids in these and other applications. One such device is called a ball mill. A ball mill typically includes a cylindrical or conical shell that rotates about a horizontal axis and is partially filled with a grinding medium such as, for example, natural flint pebbles, ceramic pellets or metallic balls. The material to be ground is added so that it slightly more than fills the voids between the individual grinding medium pieces. The shell is rotated at a speed which causes the grinding medium pieces to cascade, thus reducing the sizes of the solid material particles introduced into the shell. While ball mills have been successfully used in a number of industries, the amount of material they are able to process is often less (per hour) than other devices that actively hammer, crush or otherwise pulverize solids. In addition, the electrical cost required to operate a ball mill per ton of resultant processed solids, can be expensive and even cost prohibitive.

A recently proposed alternative to a conventional ball mill is the rotating hammer mill type solids reduction processor illustrated and described in U.S. Pat. No. 6,669,125 to Howard, such patent being hereby incorporated by reference herein in its entirety. While this solids reduction processor provides various improvements in solids reduction compared to a ball mill machine, and is generally well suited to its intended application, the processor has proven to present certain operational problems, limitations and disadvantages of its own.

For example, the solids reduction processor disclosed in U.S. Pat. No. 6,669,125, which is hereby incorporated herein by reference in its entirety, is provided with a pair of hammer-carrying rotor assemblies each having a shaft on which a spaced series of transverse support discs are coaxially welded, pairs of such discs fixedly supporting a circumferentially spaced series of radially outwardly projecting hammer members. The two shafts are rotationally supported in a spaced apart, parallel relationship, and are motor-driven in opposite rotational directions within a housing structure having an inlet opening through which solids to be reduced are introduced above the shafts, and an outlet opening through which the reduced solids outwardly pass from a location beneath the shafts. The series of disc-supported hammers on one shaft are axially offset from the series of disc-supported hammers on the other shaft so that when the two shafts are counter-rotated the rotating hammers on one shaft are interdigitated with and swing between hammer pairs on the other shaft in a radially overlapping relationship therewith.

The rigidly mounted hammers, when striking an unexpectedly large rock or the like interiorly traversing the processor, may break their connection to the support disc and swing into an adjacent rotating hammer or otherwise damage a portion of the associated rotor assembly. Further, due to the substantial radial overlap of the counter-rotating hammers, incoming solids such as rocks tend to be thrown by a given hammer directly against the shaft of the other rotor assembly and/or against a side surface portion of a disc portion of the other rotor assembly, thereby imposing very high abrasive forces on the non-hammer portions of the rotor assemblies and shortening their operating lives. This abrasion problem, which of course is not limited to the specific solids reduction processor shown in U.S. Pat. No. 6,669,125, is compounded by the necessity of replacing the entire fixedly intersecured disc and shaft portion of a rotor assembly when its shaft or any of its support discs become abraded to an unacceptable degree.

Another limitation commonly associated with hammer mill-type solids reduction processors has to do with the placement and orientation of impact or breaker bars which are suitably supported on inner side portions of the outer housing section to be struck by solids thrown off the rotating hammers and broken up into yet smaller pieces. As commonly configured and placed within the processor housing, conventional breaker bars are not operative to redirect in advantageous directions the solid objects which strike them.

As can readily seen from the foregoing, a need exists for a rotating hammer mill-type solids reduction processor of the type generally described above in which these operational limitations and disadvantages are eliminated or at least substantially reduced.

### SUMMARY OF THE INVENTION

In carrying out principles of the present invention, in accordance with representatively illustrated embodiments thereof, a specially designed solids reduction processor is provided. The processor has a housing with an inlet opening for receiving solid material to be reduced in size, and an outlet opening through which size-reduced solid material may outwardly pass. Preferably, first and second parallel, spaced apart rotor assemblies are suitably supported within the housing, and a drive system is provided for rotating the rotor assemblies in opposite directions. The rotor assemblies, during driven rotation thereof, are operative to impact and reduce the size of solid material received in the housing.

Each rotor assembly includes a shaft, a longitudinally spaced series of disc structures, illustratively a spaced apart, facing disc pair, coaxially mounted on the shaft, and a circumferentially spaced series of hammer members mounted on each disc structure for rotation relative thereto about an axis parallel to the length of the shaft. Preferably, the hammer member series on each rotor assembly are aligned with the hammer series on the other rotor assembly in a direction parallel to the shaft axes.

According to one aspect of the invention, each hammer member has an outer end portion projecting outwardly beyond the periphery of its associated supporting disc structure and being transversely enlarged in a direction parallel to the length of the shaft so that circumferentially spaced peripheral portions of the disc structure act as abutments for the outer hammer end portion to limit the available rotational arc of the hammer member. Preferably the available rotational arc of each hammer member is sized to prevent it from pivoting into engagement with any circumferentially adjacent hammer member on its associated disc structure. Illustratively, such available rotational arc of each hammer member is about twenty degrees.

According to another aspect of the invention, each rotor assembly includes a shaft, a longitudinally spaced series of disc structures rotationally locked to the shaft and being axially movable along its length for selective removal therefrom, hammer members removably secured to the disc structures in circumferentially spaced arrays thereon and projecting outwardly past their peripheries, a series of spacer members coaxially mounted on the shaft in an interdigitated relationship with the disc structures and being axially removable from the shaft, and a retaining structure removably associated with the shaft in a manner preventing axial movement of the disc structures and the spacer members relative to the shaft. Such removability of the discs, hammers and spacers permits portions of each rotor assembly to be replaced without the necessity of replacing the entire rotor assembly.

Preferably the discs are rotationally locked to their associated shaft by a spline connection. Illustratively, the shaft of each rotor assembly has an axially extending exterior surface groove thereon, each disc has a radially extending interior edge groove therein, and the spline connection is formed by keys received in the shaft groove and corresponding inner edge grooves in the discs. The spacer members preferably have annular configurations, with each spacer member coaxially circumscribing its associated shaft and being positioned between an adjacent pair of the discs. Each shaft preferably has an axially spaced pair of annular exterior surface grooves thereon, and the retainer structure includes a pair of diametrically split annular retainer plates removably secured to adjacent axially outer disc member side surfaces and having radially inner portions received in the annular exterior surface grooves on the shaft.

A breaker member is supported within the processor housing on either its top wall portion or generally vertical side wall portion and positioned to be struck on an impact surface thereof by solid objects thrown from the rotating hammer members in an ejection direction generally parallel to a line tangential to the circular path through which the hammer members rotate. Such breaker member may be positioned adjacent one rotor assembly and oriented to be transversely impacted by solid material thrown from such rotor assembly, or oriented to be transversely impacted by material thrown from the other rotor assembly. According to a further aspect of the invention such impact surface is sloped both horizontally and vertically, and is oriented generally transversely to the particle ejection direction. Due to this sloped orientation of the impact surface, the impact force of a solid particle striking it is substantially maximized. The specially oriented breaker member may be positioned in the processor housing generally below the rotor assemblies, generally above the rotor assemblies, or this type of breaker member may be positioned generally above and generally below the rotor assemblies.

In representatively illustrated methods of using it a processor embodying one or more principles of the present invention may be operated to (1) pregrind clinkers in a cement production process, (2) reduce limestone for use in flue gas de-sulfurization, (3) reduce coal for use in coal-fired utilities or burner applications, or (4) reduce fly ash to produce a very fine cement additive. In carrying out these representatively illustrative methods a solids reduction processor embodying one or more principles of the present invention may be utilized (1) by itself, (2) in series with a conventional ball mill, or (3) in series with another, substantially identical solids reduction processor.

### BRIEF DESCRIPTION OF THE DRAWINGS

FIG. 1 is an end elevational view of a specially designed solids reduction processor embodying principles of the present invention;

FIG. 2 is a side elevational view of the processor;

FIG. 3 is an enlarged scale cross-sectional view through the processor taken along line 3-3 of FIG. 2;

FIG. 4 is an enlarged scale detail view of the dashed area “4” in FIG. 3;

FIG. 5 is a side elevational view, partially in phantom, of the structure shown in FIG. 4;

FIG. 6 is a schematic, longitudinally foreshortened and partially cut away side elevational view, taken along line 6-6 of FIG. 3, of one of the rotor assemblies of the processor, with the hammer portions of the rotor assembly having been removed for illustrative clarity;

FIG. 7 is a simplified cross-sectional view through the rotor assembly taken along line 7-7 of FIG. 6;

FIG. 8 is a simplified cross-sectional view through the rotor assembly taken along line 8-8 of FIG. 6;

FIG. 9 is a simplified cross-sectional view through the rotor assembly taken along line 9-9 of FIG. 6; and

FIGS. 10-12 are schematic flow diagrams of solids reduction systems utilizing at least one solids reduction processor of the present invention.

### DETAILED DESCRIPTION

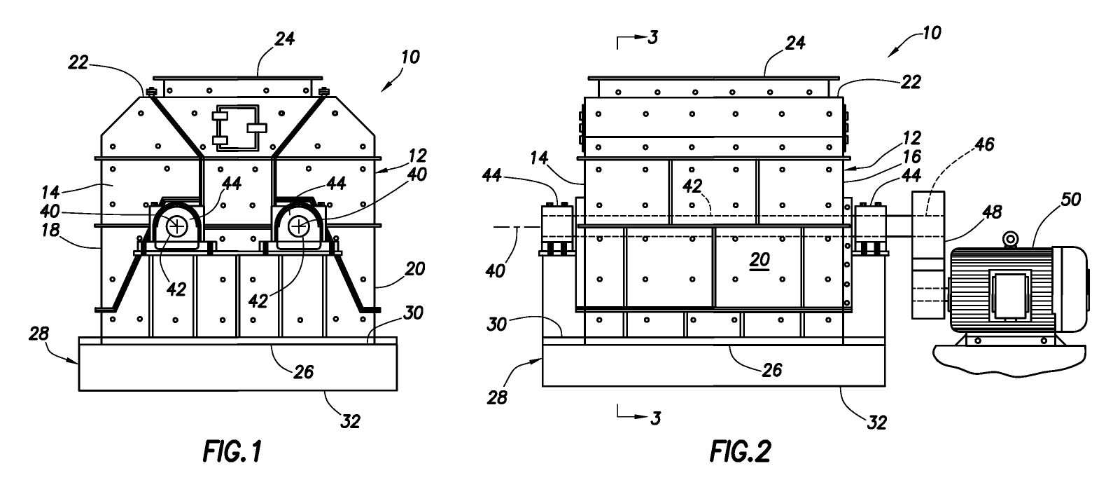

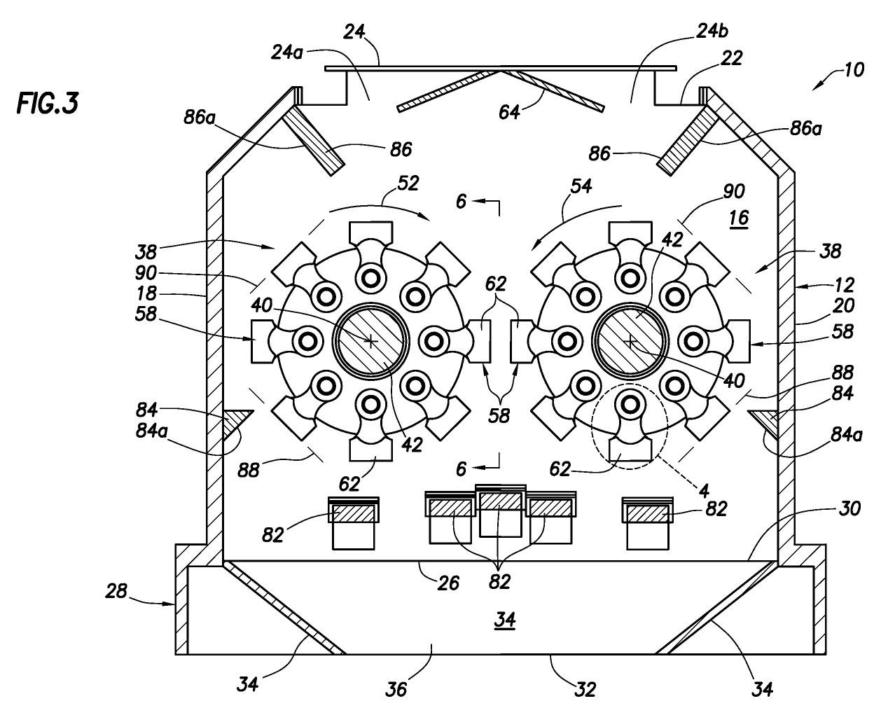

With initial reference to FIGS. 1-3, the present invention provides a specially designed hammer mill-type solids reduction processor 10 used to break up solid objects into substantially smaller objects using an impact pulverization technique. Processor 10, in its representatively illustrated form, includes a generally rectangular main housing 12 having opposite front and rear ends 14 and 16, opposite left and right sides 18 and 20, a top side 22 with an inlet opening 24 therein, and an open bottom side 26. Housing 12 is supported atop a bottom housing 28 having an open top side 30, an open bottom side 32, and downwardly and inwardly sloped interior hopper walls 34 (see FIG. 3) which form a bottom outlet opening 36 of the processor 10.

Extending through the interior of the main housing 12, between the top inlet opening 24 and the bottom outlet opening 36, are a pair of rotor assemblies 38 which are disposed in a laterally spaced relationship for rotation about vertically aligned horizontal axes 40 extending transversely through the opposite end walls 14,16 of the main housing 12. With additional reference now to FIG. 6, each rotor assembly 38 includes a cylindrical shaft 42 having opposite end portions journaled in bearing structures externally disposed on the front and rear end walls 14,16 of the main housing 12. At the rear ends of each shaft 42 is an outer drive end section 46 which is suitably coupled, as at 48, to one or more electric drive motors 50 which, with the coupling structure 48 (which may be a belt or gear structure), forms a drive system for rotating the shafts 42, and thus the rotor assemblies 38, in the opposite directions 52,54 indicated in FIG. 3. Specifically, top side portions of the rotor assemblies 38 are rotated toward one another, while bottom side portions of the rotor assemblies 38 are rotated away from one another.

Turning now to FIGS. 3 and 6, each rotor assembly 38 further includes series of longitudinally spaced support disc pairs 56,56 (see FIG. 6) coaxially mounted transversely on the shafts 42 and rotatably locked thereto, in a manner subsequently described herein, for conjoint driven rotation therewith. As best illustrated in FIGS. 3-5, inner end portions of circumferentially spaced series of hammer members 58 are disposed between the two discs in each disc pair 56,56 and are pivotally secured, as at 60, to the facing sides of their associated disc pair, with outer end portions 62 of the hammer members 58 projecting outwardly beyond the peripheries of their supporting disc pair 56,56. Preferably, the hammer members 58 in each circumferentially spaced set thereof on each rotary assembly 38 are axially aligned (i.e., in a direction parallel to the shaft axes 40) with the hammer members 58 in each circumferentially spaced set thereof on the other rotary assembly 38. Accordingly, as illustrated in FIG. 3, during driven rotation of the rotary assemblies 38, outer end portions 62 of hammer members 58 on one rotor assembly 38 are swung into and through facing relationships with outer end portions 62 of hammer members 58 on the other rotor assembly 38.

During operation of the processor 10, the rotating hammer members 58 impact and at least partially pulverize solid material dropped into the housing inlet opening 24, and additionally throw the solid material against other interior portions of the processor 10, as later described herein, to further pulverize the solid material. As shown in FIG. 3, an inverted V-shaped baffle member 64 is suitably supported in the housing inlet 24 and divides it into two opening portions 24a,24b through which separate quantities of delivered solid materials drop onto the top of the spinning rotor assemblies 38.

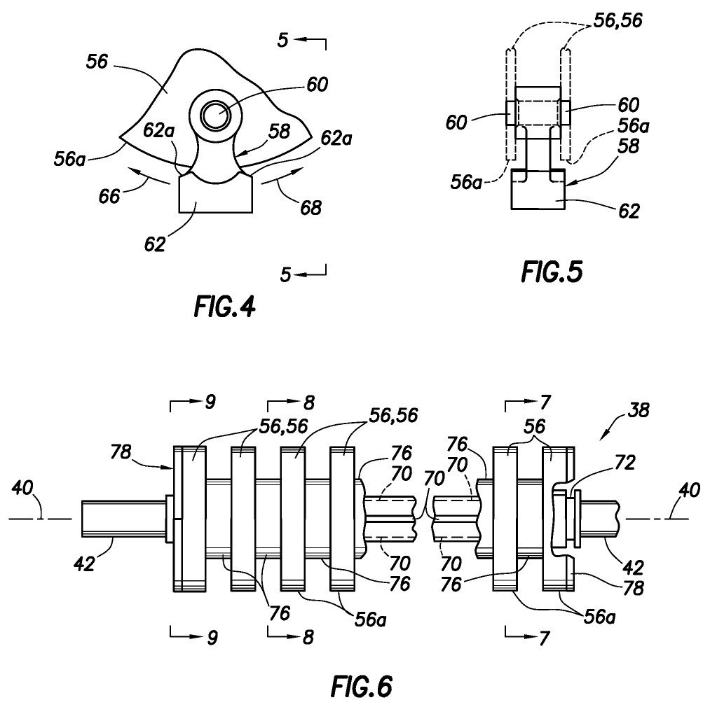

According to one aspect of the present invention, the available rotational arc of each hammer member 58 relative to its associated supporting disc pair 56,56 is limited, preferably to an angle of approximately 20 degrees, by a unique cooperation of the outwardly projecting outer end portion 62 of the hammer member 58 and the peripheries 56a of its supporting disc pair 56,56. Specifically, as may be best seen in FIGS. 4 and 5, each outer hammer member end portion 62 is enlarged in a direction parallel to the length of its associated shaft 42 so that the outer end portion 62 outwardly overlaps such disc peripheries 56a. Radially inner side corner portions 62a of each outer hammer member portion 62 are sloped as indicated in FIG. 4.

When the hammer members 58 are normally spinning about their shaft axes 40, they are generally radially oriented relative to the shafts. Due to the pivotal mounting of the hammer members 58, when any of the hammer members 58 strike a larger or harder than normal incoming solid material object, it rotationally deflects relative to its disc support structure to avoid breaking or damaging the hammer member/disc connection area. Such deflection can occur in rotationally opposite directions 66,68 shown in FIG. 4. When the rotationally deflected hammer member 58 reaches its predetermined angular deflection limit one of its tapered surfaces 62a is brought into abutment with the disc peripheries 56a to prevent further angular deflection of the hammer member 58 in that rotational direction. Illustratively, the available angular rotation of each hammer member 58 relative to its support disc structure 56,56 is selected in a manner such that even when two circumferentially adjacent hammer members 58 on the same disc pair 56 are fully rotationally deflected in opposite directions their outer end portions 62 do not strike one another.

Other aspects of the present invention advantageously reduce internal abrasion wear within the processor 10, thereby desirably lengthening the operational life of its rotor assemblies 38. For example, the previously mentioned axial alignment of the circumferentially spaced hammer member sets on the two rotor assemblies 38 reduces wear on the side surfaces of the support discs 56 and other radially inner portions of the rotor assemblies 38. Specifically, because these hammer member sets on the two rotor assemblies are axially aligned with one another, when an axially extending row of hammer members 58 on one rotor assembly 38 is swung into facing relationship with the axially extending row of hammer members 58 on the other rotor assembly 38, a solid object striking and being thrown radially outwardly from the outer end portion 62 of a given hammer member 58 in one row thereof strikes the facing outer end portion 62 of a hammer member 58 in the other row instead of being thrown between a disc pair of the other row and abrading such disc pair or the shaft-based connecting structure therebetween.

Furthering this abrasion wear reduction aspect of the present invention is a unique rotary assembly construction which will now be described in conjunction with FIGS. 6-9. As will be seen, for each rotor assembly 38 after substantial abrasion wear thereof this construction permits removal and replacement of any or all of its discs 56 without having to scrap and replace the entire rotor assembly, and additionally shields the shaft 42 from operational abrasion wear.

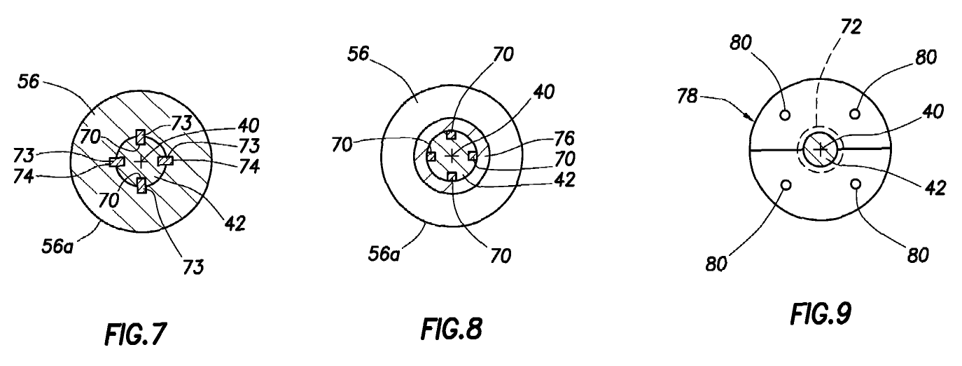

Turning now to FIGS. 6-9, in which a representative one of the two rotor assemblies 38 is illustrated, the shaft 42 has a circumferentially spaced series of longitudinally extending exterior surface grooves 70 (representatively four in number) that extend between annular exterior surface grooves 72 on opposite end portions of the shaft 42. Each disc 56 has an annular configuration and is coaxially mounted on and spline-connected to the shaft 42 by means of rectangular key members 73 (see FIG. 7), each of which extends into one of the longitudinally extending shaft grooves 70 and a corresponding inner edge groove 74 formed in the disc 56. This spline connection permits each disc 56 to be axially installed on and removed from the shaft 42. Other types of spline-type connections could alternatively be utilized to rotationally lock the discs 56 on the shaft 42. For example, radial projections could be formed on the shaft and extend into interior surface grooves on the discs, or radial projections could be formed on the inner edges of the discs and extend into the shaft grooves 70.

The discs 56 are maintained in their indicated axially spaced apart orientation on the shaft 42 by a series of annular spacer members 76 coaxially and slidably telescoped onto the shaft 42 in an interdigitated relationship with the discs 56. The discs 42 and the spacers 76 are captively retained on the shaft 42 by annular, diametrically split end plates 78 having radially inner edge portions received in the annular shaft grooves 72, the halves of each end plate 78 being removably secured to the axially outermost discs 45 by, for example, bolts 80.

This modular construction of the rotor assemblies 38 permits ready removal and replacement of some or all of the discs 56 on a rotor assembly 38, when they become operationally abraded, without having to scrap the entire rotor assembly. Such removal of the discs 56 (with or without the hammer members 58 thereon) may be accomplished simply by removing the end plates 78 to thereby permit the discs 56 and spacers 76 to be axially slid off the shaft 42. New discs 56 and/or spacers 76 may then be re-installed on the shaft 42 and again locked in place thereon by re-installing the split annular end plates 78 on the shaft 42. It should be noted that the annular spacer members 78 not only maintain the desired axial spacing between adjacent pairs of the discs 56, but also shield the axial portion of the shaft 42 disposed within the processor housing 12 from operational abrasion wear.

Returning now to FIG. 3, partially size-reduced solid materials thrown outwardly from the spinning rotor assembly hammer members 58 are further reduced in size by impact members in the form of elongated, horizontally supported breaker bars 82,84,86 longitudinally extending through the interior of the main housing 12 between its opposite front and rear ends 14 and 16. Such size-reduced solid materials thrown outwardly from the spinning rotor assembly hammer members 58 forcibly strike these breaker bars and are further pulverized and size-reduced before exiting the hoppered bottom housing outlet opening 36.

Breaker bars 82, whose top sides are horizontally oriented, are positioned in a row along an interior bottom side portion of the main housing 12 beneath the rotor assemblies 38 to be impacted on their horizontal top sides by solid materials thrown downwardly from the spinning rotor assemblies. Breaker bars 84 are positioned on the inner sides of the vertical housing side walls 18,20 somewhat above the levels of the bottom sides of the rotor assemblies 38, and the breaker bars 86 are positioned above the rotor assemblies 38 on the inner side of the top housing wall 22 adjacent opposite sides of the inlet opening 24. According to a further aspect of the present invention, the breaker bars 84,86 respectively have bottom impact surfaces 84a,86a which are horizontally and vertically sloped as viewed in FIG. 3.

Specifically, the impact surfaces 84a are sloped downwardly and horizontally away from the rotor assemblies 38 so that solid material thrown outwardly from the spinning rotor assemblies 38 generally parallel to lines 88 tangent to the circles through which the outer hammer member end portions 62 are rotationally driven strike the impact surfaces 84a generally perpendicularly thereto (as opposed to striking them at a glancing angle if the impact surfaces 84a were vertically oriented) to substantially increase the solid material pulverization action of the breaker bars 84. In a similar manner the impact surfaces 86a are sloped downwardly and horizontally toward the rotor assemblies 38 so that solid material thrown upwardly from the spinning rotor assemblies 38 generally parallel to lines 90 tangent to the circles through which the outer hammer member end portions 62 are rotationally driven strike the impact surfaces 86a generally perpendicularly thereto (as opposed to striking them at a glancing angle if the impact surfaces 86a were horizontally oriented) to substantially increase the solid material pulverization action of the breaker bars 86. As can be seen, the unique use of the specially configured and positioned breaker structures 84,86 desirably increases the overall solid material pulverization efficiency of the representatively illustrated reduction processor 10.

In the representatively illustrated angular orientations of the upper breaker members 86 their side surfaces 86a are, as discussed above, generally transversely impacted by solid material thrown off the left and right rotor assemblies 38 along the tangent lines 90. Additionally, as viewed in FIG. 3, the side of the right breaker member 86 opposite its impact surface 86a is impacted by solid material thrown rightwardly from the left rotor assembly 38, and the side of the left breaker member 86 opposite its impact surface 86a is impacted by solid material thrown leftwardly from the right rotor assembly 38. As can be seen, this rotor assembly-ejected “crossover” flow of solid material tends to strike these opposite side surfaces of the upper breaker members 86 at relatively glancing angles. If it is desired to maximize the pulverization efficiency of the upper breaker members 86 relative to this “crossover” flow of ejected solid material, they may be oriented within the interior of the housing 12 such that these breaker bar side surfaces opposite their impact surfaces 86a are generally vertically oriented and are thus generally transversely struck by the ejected solids crossover flow within the housing 12.

As can be seen from the foregoing, the various unique features incorporated in the representatively illustrated solids reduction processor 10 of the present invention provide it with enhanced abrasion wear resistance, improved solid material pulverization efficiency, and rotor assembly maintenance cost reduction.

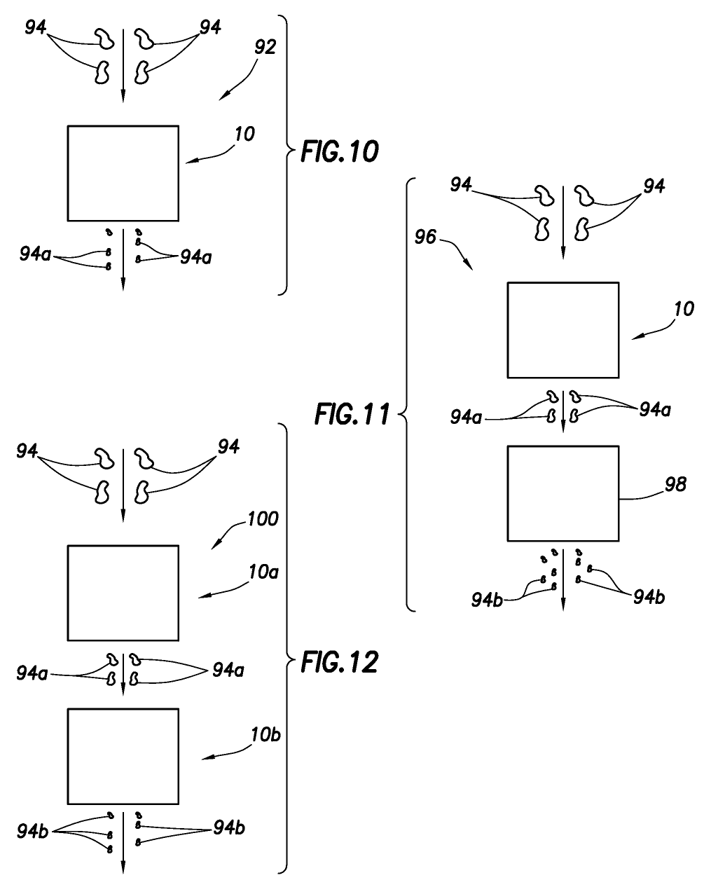

As schematically depicted in FIGS. 10-12, the improved solids reduction processor 10 of the present invention may be utilized to advantage in various specific solid material reduction applications. For example, in the method 92 shown in FIG. 10, the processor 10 may be utilized by itself to receive solid material 94 and discharge, as a finished product, considerably smaller particles 94a of the received solid material 94. In a first representative embodiment of the method 92 the received material 94 comprises clinkers (kiln-fired limestone particles) which are reduced by the processor 10 to smaller clinker particles 94a for supply to a finishing grinder that produces from the particles 94a a fine cement powder. In a second representative embodiment thereof the method 92 may be used to reduce limestone 94 to produce a finer limestone material 94a for use in a flue gas de-sulfurization process. In a third representative embodiment thereof the method 92 may be used to reduce coal 94 to a smaller size 94a for use in coal-fired utilities or burners. In a fourth representative embodiment thereof the method 92 may be used to reduce fly ash 94 to a very fine size 94a for use as a cement additive.

In the method 96 schematically depicted in FIG. 11, the outlet of the processor 10 is operatively connected to the inlet of a conventional ball mill 98 which functions to receive the size-reduced solid particles 94a discharged from the processor 10 and further reduce the particles to even finer sized particles 94b discharged from the ball mill 98. This series-connected combination of the processor 10 and the ball mill 98 may be used in any of the four solids reduction processes representatively described above in conjunction with method 92.

In the method 100 schematically depicted in FIG. 12, two processors 10a,10b of the present invention are connected in series as shown such that the size-reduced particles 94a discharged from the upstream processor 10a are run through the downstream processor 10b to produce even finer particles 94b. This series-connected combination of the processors 10a,10b may be used in any of the four solids reduction processes representatively described above in conjunction with method 92. Of course, more than one additional processor 10 may connected in series with the upstream processor 10.

The foregoing detailed description is to be clearly understood as being given by way of illustration and example only, the spirit and scope of the present invention being limited solely by the appended claims.

What is claimed is:

1. A solids reduction processor comprising:
a housing having an inlet opening for receiving solid material to be reduced in size and an outlet opening through which size-reduced solid material may outwardly pass;
a rotor assembly supported within said housing in a parallel relationship and being operative to impact and reduce the size of solid material received in said housing, said rotor assembly including a shaft, a longitudinally spaced series of disc structures coaxially mounted on the shaft, and a circumferentially spaced series of hammer members mounted on each disc structure for rotation relative thereto about an axis parallel to the length of the shaft,
each hammer member having an outer end portion projecting outwardly beyond the periphery of the disc structure and being transversely enlarged in a direction parallel to the length of the shaft so that circumferentially spaced peripheral portions of the disc structure act as abutments for the outer hammer end portion to limit the available rotational arc of the hammer member; and
a drive system for rotating said rotor assembly.

2. The solids reduction processor of claim 1 wherein:
each disc structure includes a spaced pair of discs between which an inner end portions of a plurality of said hammer members are pivotally mounted.

3. The solids reduction processor of claim 1 wherein:
the available rotational arc of each hammer member is sized to prevent it from pivoting into engagement with any circumferentially adjacent hammer member on its associated disc structure.

4. The solids reduction processor of claim 1 wherein:
said rotor assembly is a first rotor assembly,
said solids reduction processor further comprises a second rotor assembly parallel to and substantially identical to said first rotor assembly, and
said drive system is operative to rotate said first and second rotor assemblies in opposite directions.

5. The solids reduction processor of claim 4 wherein:
the hammer members mounted on each disc structure form a hammer set, and
the hammer sets on said first and second rotor assemblies are aligned with one another in a direction parallel to the axes of the shafts of said first and second rotor assemblies.

6. A solids reduction processor comprising:
a housing having an inlet opening for receiving solid material to be reduced in size and an outlet opening through which size-reduced sold material may outwardly pass;
a rotor assembly supported within said housing and being operatively rotatable to impact and reduce the size of solid material received in said housing, said rotor assembly including a shaft, a longitudinally spaced series of disc structures rotationally locked to said shaft and being axially movable along its length for selective removal therefrom, hammer members removably secured to the disc structures in circumferentially spaced arrays thereon and projecting outwardly past their peripheries, a series of spacer members coaxially mounted on said shaft in an interdigitated relationship with said disc structures and being axially removable from said shaft, and a retaining structure removably associated with said shaft in a manner preventing axial movement of said disc structures and said spacer members relative to said shaft; and
a drive system for operatively rotating said rotor assembly.

7. The solids reduction processor of claim 6 wherein:
each of said disc structures includes a spaced apart pair of coaxial, annularly shaped discs rotationally locked to said shaft by a spline connection.

8. The solids reduction processor of claim 7 wherein:
said shaft has an axially extending exterior surface groove thereon,
each of said discs in said pair thereof has a radially extending interior edge groove therein, and
said spline connection includes key members received in said shaft groove and said disc grooves.

9. The solids reduction processor of claim 7 wherein:
said spacer members have annular configurations, each spacer member coaxially circumscribing said shaft and being positioned between an adjacent pair of said discs.

10. The solids reduction processor of claim 6 wherein:
said shaft has an axially spaced pair of annular exterior surface grooves thereon, and
said retainer structure includes a pair of diametrically split annular retainer plates removably secured to adjacent axially outer disc structure side surfaces and having radially inner portions received in said annular exterior surface grooves.

11. The solids reduction processor of claim 6 wherein:
said rotor assembly is a first rotor assembly,
said solids reduction processor further comprises a second rotor assembly parallel to and substantially identical to said first rotor assembly, and
said drive system is operative to rotate said first and second rotor assemblies in opposite directions.

12. The solids reduction processor of claim 11 wherein:
the hammer members mounted on each disc structure form a hammer set, and
the hammer sets on said first and second rotor assemblies are aligned with one another in a direction parallel to the axes of the shafts of said first and second rotor assemblies.

13. A solids reduction processor comprising:
a housing having an upper inlet opening for receiving solid material to be reduced in size, a lower outlet opening, vertically separated from said upper inlet opening, through which size-reduced solid material may outwardly pass, a top wall portion and a side wall portion extending downwardly from said top wall portion;
a rotor assembly supported within said housing between said inlet and outlet openings and being operatively rotatable about a generally horizontal axis to impact and reduce the size of solid material received in said housing, said rotor assembly including a circumferentially spaced series of hammer members having outer end portions which, during operative rotation of said rotor assembly, rotate through a circular path;
a drive system for operatively rotating said rotor assembly; and
a breaker member supported within said housing on one of said top and side wall portions and positioned to be struck on an impact surface thereof by solid objects thrown from the rotating hammer members in an ejection direction generally parallel to a line tangential to said circular path and transverse to said impact surface.

14. The solids reduction processor of claim 13 wherein:
said impact surface is sloped in both horizontal and vertical directions.

15. The solids reduction processor of claim 13 wherein:
said rotor assembly is a first rotor assembly,
said solids reduction processor further comprises a second rotor assembly parallel to and substantially identical to said first rotor assembly, and
said drive system is operative to rotate said first and second rotor assemblies in opposite directions.

16. The solids reduction processor of claim 15 wherein:
the hammer members mounted on each disc structure form a hammer set, and
the hammer sets on said first and second rotor assemblies are aligned with one another in a direction parallel to the axes of the shafts of said first and second rotor assemblies.

17. The solids reduction processor of claim 13 wherein:
said breaker member is positioned generally below said rotor assembly.

18. The solids reduction processor of claim 13 wherein:
said breaker member is positioned generally above said rotor assembly.

19. The solids reduction processor of claim 15 wherein:
said breaker member is positioned adjacent said first rotor assembly, and
said impact surface is oriented to be impacted by solid material thrown generally horizontally from the hammer members of said second rotor assembly.

20. The solids reduction processor of claim 19 wherein:
said breaker member is operatively supported on said top wall portion of said housing.

21. The solids reduction processor of claim 20 wherein:
said impact surface is angled relative to said top wall portion of said housing.

22. A solids reduction method comprising the steps of:
providing a solids reduction processor comprising a housing having an inlet opening for receiving solid material to be reduced in size and an outlet opening through which size-reduced solid material may outwardly pass, a rotor assembly supported within said housing in a parallel relationship and being operative to impact and reduce the size of solid material received in said housing, said rotor assembly including a shaft, a longitudinally spaced series of disc structures coaxially mounted on the shaft, and a circumferentially spaced series of hammer members mounted on each disc structure for rotation relative thereto about an axis parallel to the length of the shaft, each hammer member having an outer end portion projecting outwardly beyond the periphery of the disc structure and being transversely enlarged in a direction parallel to the length of the shaft so that circumferentially spaced peripheral portions of the disc structure act as abutments for the outer hammer end portion to limit the available rotational arc of the hammer member; and a drive system for rotating said rotor assembly;
introducing a solid material into said inlet opening; and
operating said solids reduction processor to reduce in size the received solid material and discharge the size-reduced solid material through said outlet opening.

23. The solids reduction method of claim 22 wherein:
said introducing step is performed by introducing into said inlet opening a solid material selected from the group consisting of clinkers, limestone, coal and fly ash.

24. The solids reduction method of claim 22 further comprising the step of:
connecting the outlet opening of said solids reduction processor to the inlet opening of a second solids reduction apparatus.

25. The solids reduction method of claim 24 wherein:
said introducing step is performed by introducing into said inlet opening of said solids reduction processor a solid material selected from the group consisting of clinkers, limestone, coal and fly ash.

26. The solids reduction method of claim 24 wherein:
said connecting step is performed by connecting the outlet opening of said solids reduction processor to the inlet opening of a ball mill.

27. The solids reduction method of claim 24 wherein:
said connecting step is performed by connecting the outlet opening of said solids reduction processor to the inlet opening of a second, substantially identical solids reduction processor.

28. A solids reduction method comprising the steps of:
providing a solids reduction processor having a housing having an inlet opening for receiving solid material to be reduced in size and an outlet opening through which size-reduced sold material may outwardly pass, a rotor assembly supported within said housing and being operatively rotatable to impact and reduce the size of solid material received in said housing, said rotor assembly including a shaft, a longitudinally spaced series of disc structures rotationally locked to said shaft and being axially movable along its length for selective removal therefrom, hammer members removably secured to the disc structures in circumferentially spaced arrays thereon and projecting outwardly past their peripheries, a series of spacer members coaxially mounted on said shaft in an interdigitated relationship with said disc structures and being axially removable from said shaft, and a retaining structure removably associated with said shaft in a manner preventing axial movement of said disc structures and said spacer members relative to said shaft, and a drive system for operatively rotating said rotor assembly;
introducing a solid material into said inlet opening; and
operating said solids reduction processor to reduce in size the received solid material and discharge the size-reduced solid material through said outlet opening.

29. The solids reduction method of claim 28 wherein:
said introducing step is performed by introducing into said inlet opening a solid material selected from the group consisting of clinkers, limestone, coal and fly ash.

30. The solids reduction method of claim 28 further comprising the step of:
connecting the outlet opening of said solids reduction processor to the inlet opening of a second solids reduction apparatus.

31. The solids reduction method of claim 30 wherein:
said introducing step is performed by introducing into said inlet opening of said solids reduction processor a solid material selected from the group consisting of clinkers, limestone, coal and fly ash.

32. The solids reduction method of claim 30 wherein:
said connecting step is performed by connecting the outlet opening of said solids reduction processor to the inlet opening of a ball mill.

33. The solids reduction method of claim 30 wherein:
said connecting step is performed by connecting the outlet opening of said solids reduction processor to the inlet opening of a second, substantially identical solids reduction processor.

34. A solids reduction method comprising the steps of:
providing a solids reduction processor having a housing having an upper inlet opening for receiving solid material to be reduced in size, a lower outlet opening, vertically separated from said upper inlet opening, through which size-reduced solid material may outwardly pass, a top wall portion and a side wall portion extending downwardly from said top wall portion, a rotor assembly supported within said housing between said inlet and outlet openings and being operatively rotatable about a generally horizontal axis to impact and reduce the size of solid material received in said housing, said rotor assembly including a circumferentially spaced series of hammer members having outer end portions which, during operative rotation of said rotor assembly, rotate through a circular path, a drive system for operatively rotating said rotor assembly, and a breaker member supported within said housing on one of said top and side wall portions and positioned to be struck on an impact surface thereof by solid objects thrown from the rotating hammer members in an ejection direction generally parallel to a line tangential to said circular path and transverse to said impact surface;
introducing a solid material into said inlet opening; and
operating said solids reduction processor to reduce in size the received solid material and discharge the size-reduced solid material through said outlet opening.

35. The solids reduction method of claim 34 wherein:
said introducing step is performed by introducing into said inlet opening a solid material selected from the group consisting of clinkers, limestone, coal and fly ash.

36. The solids reduction method of claim 34 further comprising the step of:
connecting the outlet opening of said solids reduction processor to the inlet opening of a second solids reduction apparatus.

37. The solids reduction method of claim 36 wherein:
said introducing step is performed by introducing into said inlet opening of said solids reduction processor a solid material selected from the group consisting of clinkers, limestone, coal and fly ash.

38. The solids reduction method of claim 36 wherein:
said connecting step is performed by connecting the outlet opening of said solids reduction processor to the inlet opening of a ball mill.

39. The solids reduction method of claim 36 wherein:
said connecting step is performed by connecting the outlet opening of said solids reduction processor to the inlet opening of a second, substantially identical solids reduction processor.
